(19) United States
(12) Patent Application Publication
(10) Pub. No.: US 2013/0167315 A1
(43) Pub. Date: Jul. 4, 2013

(54) WINDSCREEN WIPER ADAPTER WITH ELECTRICAL CONTACTS

(71) Applicants: Gérald Caillot, Cernay La Ville (FR); Vincent Izabel, Chilly Mazarin (FR); Jean-Michel Jarasson, Le Mesnil-St-Denis (FR)

(72) Inventors: Gérald Caillot, Cernay La Ville (FR); Vincent Izabel, Chilly Mazarin (FR); Jean-Michel Jarasson, Le Mesnil-St-Denis (FR)

(73) Assignee: VALEO SYSTEMES D'ESSUYAGE, Le Mesnil Saint Denis (FR)

(21) Appl. No.: 13/805,683

(22) PCT Filed: Jun. 22, 2011
(86) PCT No.: PCT/EP11/60513

§ 371 Date: Mar. 13, 2013

(30) Foreign Application Priority Data
Jun. 30, 2010 (FR) 10/02787

(51) Int. Cl. B60S 1/38

(52) U.S. Cl. CPC B60S 1/3805
USPC 15/250.06; 15/250.32

(57) ABSTRACT

Adapter (5) for mounting a windscreen wiper (3) on an arm (1) for actuating said wiper,

characterized in that it comprises an electricity conducting device (12).

The field of the present invention is that of equipment for vehicles and more particularly that of equipments for wiping the windscreen of motor cars.

Motor cars are routinely equipped with wiping and washing systems for wiping and washing the windscreen and preventing distortion of the view that the driver has of their environment. These wiping systems comprise arms effecting an angular to-and-fro movement, at the end of which are installed elongate wipers themselves carrying squeegee blades produced in an elastic material. These blades rub against the windscreen and evacuate the water out of the field of view of the driver. The wipers are produced in the form, either, in a classic version, of articulated brackets that hold the squeegee blade at a plurality of discrete locations, or, in a more recent, so-called “flat blade” version, a semi-rigid assembly that holds the squeegee blade over all its length. In both solutions the wiper is attached to the turning arm of the windscreen wiper by an assembly consisting of a mechanical connector and an adapter. The connector is a part that is fixed directly to the structure of the wiper or directly to the flat blade, the adapter being an intermediate part enabling fixing of the connector to the windscreen wiper arm. These two parts are connected to each other by a transverse shaft that allows relative rotation thereof.

Windscreen wipers are also equipped with devices for feeding a windscreen washing liquid that is fed from a tank situated on the vehicle and that is sprayed in the direction of the windscreen by nozzles generally situated on the bonnet or on the grille of the windscreen frame, or on the windscreen wiper itself for improved distribution of the liquid. In the case of nozzles placed on the wipers, the windscreen washing liquid is fed, before being distributed between them, by pipes that are fixed to the arm of the windscreen wiper and that are connected to the distribution system of the wiper at the level of the connector. The connector thus includes orifices adapted to receive the ends of said pipes by way of a watertight connection.

Also encountered in the motor vehicle after-sales service field are devices for heating the windscreen for de-icing the wiper in very cold weather and preventing ice from sticking it to the windscreen. These devices, which are more specifically suited to flat blade wipers, generally include a heating device integrated into the assembly supporting the squeegee blade and on which electrical heating resistances are disposed. They also necessitate an electrical connection device, placed at the level of the connector, for transmitting to the heating device the electrical current coming from the vehicle.

It is therefore important to provide the electrical connection between the power supply wire carried by the windscreen wiper arm and the heating device of the corresponding wiper, under conditions of maximum simplicity and minimum induced cost, which connection must also be removable whilst guaranteeing perfect continuity of the electrical current between the component parts of the windscreen wiper.

The object of the present invention is to improve on the situation by proposing an electrical connection device between the connector and the arm that is easy to produce and that produces a stable contact between the elements so as to ensure electrical continuity regardless of loads induced by vibrations, imperfections of the road or replacement of the windscreen wiper.

To this end, the invention consists in an adapter for mounting a windscreen wiper on an arm for actuating said wiper, novel in that it comprises an electricity conducting device. Thus an intermediate and adaptive part is provided between the connector and the yoke that is able to transport the electrical current.

According to a first feature of the invention, the electricity conducting device includes first and second flexible means. Accordingly, the invention guarantees that electrical contact is made reliably, and in a stable and durable manner. Through metal parts forming springs or having a flexible shape or property, the electrical contacts guarantee a good and permanent electrical contact, even if the assembly is subjected to loads, notably vibrations or impacts, suffered by the wiper system, as a consequence of imperfections of the road on which the vehicle is moving.

According to a second feature, the electricity conducting device has an angle-iron shape connected to said adapter, from which extends at least one first or one second tongue forming first or second flexible means.

At least one of the tongues advantageously has a boss at its free end. This boss forms the point of contact at which the electricity passes, its rounded shape guaranteeing its passage even if the contacts concerned are oriented angularly relative to each other.

The electricity conducting device more advantageously takes the form of a bent metal plate.

The invention also consists in an assembly for fixing a windscreen wiper provided with a heating device to an actuating arm of said wiper, comprising a connector on which are positioned a second electrical contact and an adapter having anyone of the above features.

The electricity conducting device of the above assembly is in contact with the second electrical contact via a second tongue of the electricity conducting device.

The invention also consists in a windscreen wiper comprising a heating device characterized in that it comprises a fixing assembly as referred to above.

In this wiper, the second electrical contact feeds said heating device with electricity, this latter device comprising at least one heating resistance implanted on at least one sole or vertebra of the wiper.

Finally, the invention also protects a vehicle windscreen wiper comprising an arm provided with a yoke and a wiper having any one of the above features.

The electricity conducting device advantageously comes to bear against a first electrical contact of the yoke and against the second electrical contact of the connector.

The first tongue more advantageously extends longitudinally, said adapter being conformed to be integrated into the yoke by a rotation about a shaft transverse to the longitudinal direction of the arm.

According to one feature of the windscreen wiper, the second tongue extends transversely relative to the longitudinal direction of the arm, said adapter being conformed to receive the connector through longitudinal translation.

According to a further feature of the windscreen wiper, the second tongue extends longitudinally, said adapter being conformed to be integrated into the connector by a rotation about a shaft transverse to the longitudinal direction of the arm.

The invention will be better understood, and other objects, details, features and advantages thereof will become more clearly apparent, in the light of the following detailed explanatory description with reference to the appended diagrammatic drawings of a plurality of embodiments of the invention that are purely illustrative and not limiting on the invention.

In these drawings:

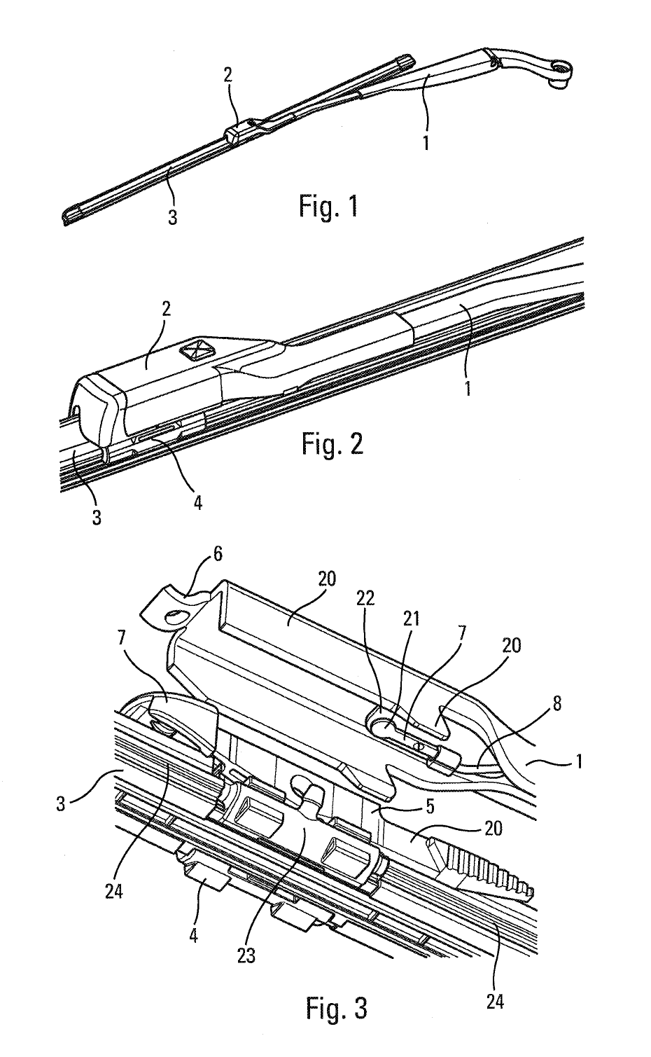

FIG. 1 is a general perspective view of a windscreen wiper for motor vehicles;

FIG. 2 shows a detail of FIG. 1;

FIG. 3 is a perspective view of an assembly comprising a windscreen wiper arm, an adapter, a connector and a windscreen wiper;

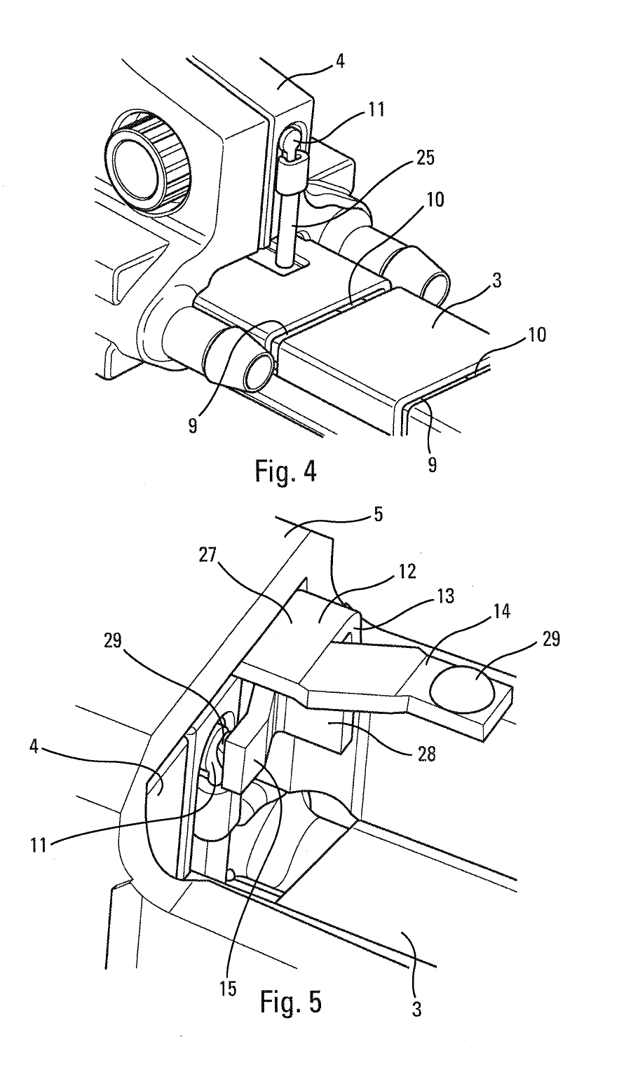

FIG. 4 is a perspective view of the rear portion of a connector mounted on a windscreen wiper;

FIG. 5 is a perspective view of the rear portion of the connector from FIG. 4 in position in an adapter conforming to one embodiment of the invention, and

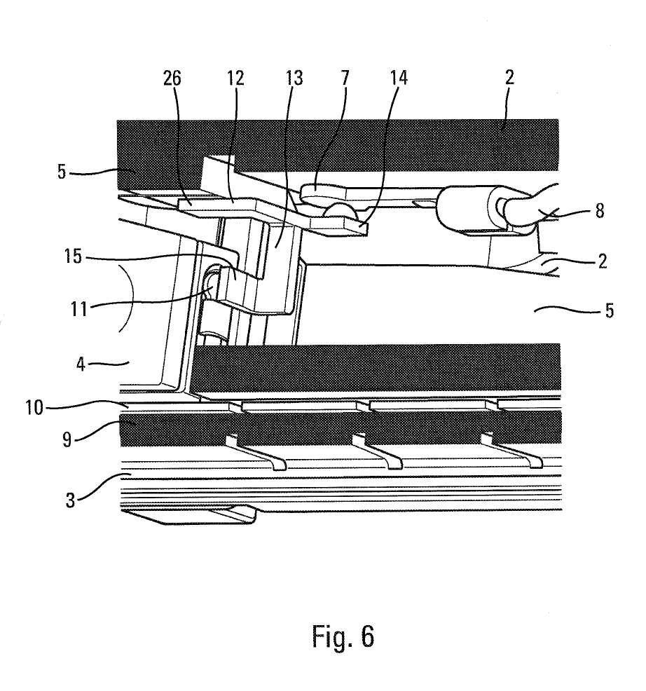

FIG. 6 is a perspective view of a connector and adapter of one embodiment of the invention in place on a windscreen wiper arm.

It should be noted that the figures disclose the invention in detail; said figures may of course serve to define the invention better where necessary.

Referring to FIGS. 1 and 2, there is seen a windscreen wiper classically composed of a wiper support, actuating arm or arm 1 terminating at its end in a yoke 2, which is fixed to the arm 1 by crimping it and the function of which is, via an adapter, to support the wiper 3 equipped with its connector 4. Alternatively, this yoke may equally be formed at the end of the arm by deformation thereof and constitute with the arm a unitary assembly.

In the present invention, the adapter is a part having at least two functions. A first function is to form the mechanical connection between the connector of the wiper and the yoke at the end of the arm in an adaptive manner, i.e. for the same arm but for a multiplicity of different wipers, for example. The converse is equally possible. The second function of the adapter of the invention is to conduct electrical energy from the arm to the wiper.

Referring now to FIG. 3, there is seen the arm 1 that is extended at its end by the yoke 2 intended to receive the adapter 5. The latter is mounted on a connector 4, which is itself crimped to the structure of the windscreen wiper 3.

The yoke 2 has at its free end, i.e. at the end opposite that which receives the arm 1, an adapter support means represented in the form of a curved tongue 6 that is intended to be inserted under the terminal portion 7 of the adapter, which is known to persons skilled in the art as a cap and which, in addition to this function of retaining the adapter 5 on the yoke 2, contributes to the overall aesthetic effect.

In the version represented, the adapter 5 is fitted to the arm 1 by rotation of the adapter 5 about a shaft perpendicular to the longitudinal direction of the arm, i.e. the direction in which said arm extends, and passing through the curved tongue 6, pivoting along the curved tongue 6. At its end of travel, the adapter is engaged in the yoke 2 by appropriate retaining means 20 that retain it in its final operating position.

In the version represented, the engagement of the adapter 5 is effected by rotation of the adapter 5 about a shaft perpendicular to the longitudinal direction of the arm, i.e. the direction in which said arm extends, and passing through the curved tongue 6, but the invention could equally well be applied to a windscreen wiper in which the adapter is engaged in the yoke 2 by translation in the longitudinal direction of the arm 1 or by any other assembly configuration known to persons skilled in the art.

The yoke 2 has a U-shaped section capping the adapter 5. This yoke 2 carries on its internal face a first electrical contact 7 that is connected to a power supply wire 8 of the heating device integrated into the wiper 3. The first electrical contact 7 terminates in a flat circular metal paddle 21 that makes a clear electrical contact with a corresponding electrical contact placed in the adapter, to be described in detail later. An electrical insulator 22 is disposed between the internal face of the yoke 2 and the first electrical contact 7, this insulator taking the form of a plastic foil. Of course, it is necessary to feed both electrical potentials and it will be obvious that the invention covers the presence of another electrical contact that is connected to another power supply wire of the heating device integrated into the wiper 3. Like the first electrical contact 7, this other electrical contact terminates in a flat circular metal paddle that makes a clear electrical contact with a corresponding electrical contact placed on the adapter. The description given hereinafter thus applies in all regards to this other electrical contact.

Thus the positive potential and the negative potential pass from the arm to the wiper via the adapter.

The first electrical contact 7 is fixed to the yoke 2 by a screw or other known fastening means, substantially in alignment with the retaining means 20 between the yoke 2 and the adapter 5.

This figure also shows the presence of feed nozzles 23 that supply distribution manifolds 24 with windscreen washing liquid, the latter manifolds extending longitudinally along the wiper 3 on each side thereof.

In FIG. 4 there is seen a connector 4 crimped to a wiper 3. The latter includes a rigid part 9, called the vertebra, the function of which is to serve as a mechanical reinforcement for a squeegee blade of the wiper. A heating device or element taking the form of a heating resistance 10 runs the entire length of the vertebra 9 and heats it. At the level of the connector 4, the heating resistance 10 is connected to a second electrical contact 11 via a conductive rod 25. This second electrical contact 11 is intended to receive and to conduct the electrical current coming from the first electrical contact 7 and the power supply wire 8 via an electricity conducting device attached to the adapter 5.

FIG. 5 shows the connector 4 in position in the adapter 5. This adapter has a parallelepiped general shape in which its length defines its longitudinal direction and its width defines its transverse direction.

To this adapter is fixed an electricity conducting device 12 the function of which is to make the electrical connection between the first electrical contact 7 placed on the yoke 2 and the second electrical contact 11 positioned on the connector 4. This electricity conducting device is constituted of a bent metal plate and has the shape of an angle-bracket 13 that is rigidly fixed to the adapter by a fastening arm (reference 26 in FIG. 6) connected to the angle-bracket 13. This angle-bracket 13 includes two flats 27 and 28 at a right angle to each other. There is a tongue at the end of each flat 27 and 28. A first tongue 14 extends in a direction perpendicular to the direction in which the flat 27 extends and a second tongue 15 for its part extends perpendicularly to the direction in which the flat 28 extends. These tongues 14 and 15 serve as intermediate electrical contacts with and between the first and second electrical contacts 7 and 11, respectively.

Each of these tongues includes at the level of its free end a boss 29 intended to improve the electrical connection with these first and second electrical contacts according to their angular positions. The first tongue 14 extends in the longitudinal direction at the end of the flat 27 and has a thickness such that it behaves as a spring in the case of a vertical bearing force exerted on the boss 29. Similarly, the second tongue extends in the transverse direction, i.e. in the direction orthogonal to the longitudinal direction of the adapter, from a lateral edge surface of the flat 28. It also has a thickness such that it behaves as a spring in the case of longitudinal pressure applied to its boss 29. This appropriate thickness imparts the suppleness and the flexibility necessary for the tongues 14 and 15 to be deformed whilst maintaining a bearing force of the bosses 29 on the paddles of the first and second electrical contacts 7 and 11.

It will especially be noted that the boss 29 on the first tongue 14 lies in a plane parallel to but separate from the plane in which the flat 27 lies. Similarly, the plane in which the boss 29 of the second tongue 15 lies is parallel to but separate from the lateral edge surface of the flat 28.

FIG. 6 shows the complete assembly of a connector 4 installed in an adapter 5 which is itself mounted on the yoke 2 of an arm 1. For reasons of the legibility of the figure, the adapter 5, the wiper 3 and the yoke 2 are represented by only one of their halves, sectioned longitudinally; only the portion behind the plane of the figure is shown, the portion situated in front of it having been removed to render the internal constitution of the assembly visible.

In this configuration, the adapter 5 is engaged in the yoke 2, which generates a force by virtue of which the first contact 7 bears on the first tongue 14 via its boss 29. The pressing of the first contact 7 against the electricity conducting device 12 is made possible by the flexibility of the first tongue 14 and the spring effect that it produces guarantees stable and durable contact between the two electrical contacts regardless of any loads or vibrations to which the wiper system is subjected linked to imperfections of the road or when the wiper is replaced as part of after-sales service.

Similarly, the contact between the second electrical contact 11 and the electricity conducting device 12 is effected at a pressure that results from the force with which the connector 4 is engaged in the adapter 5. Again, the spring effect procured by the second tongue 15 guarantees a stable contact between the two electrical contacts.

There will now be described the mounting of a wiper 3 on an arm 1 of a motor vehicle windscreen wiper system with the aid of an adapter 5 including an electricity conducting device 12 conforming to one embodiment of the invention.

The operator engages the adapter 5 on the connector 4 of the wiper 3 and engages it by compressing nesting means provided for this purpose on the adapter. This forces the second electrical contact 11 to bear against the second tongue 15, which is deformed longitudinally and thus forms a spring.

The operator then engages the curved tongue 6 of the yoke 2 under the cap 7 and causes the adapter 5 to pivot so that it assumes its place in the yoke 2. This action relies on deformation of retaining means 20 of the adapter. Once fixed, the first electrical contact 7 comes to bear against the electricity conducting device 12. Once the adapter has been fitted, the first and second electrical contacts 7 and 11 bear firmly against the first and second tongues 14 and 15, which ensures a permanent electrical contact and good electricity continuity from the power supply wire 8 to the heating device consisting of the heating resistance 10 implanted on the vertebra 9.

1. An adapter for mounting a windscreen wiper on an arm for actuating said wiper, comprising an electricity conducting device.

2. The adapter according to claim 1, wherein the electricity conducting device comprises first and second flexible means.

3. The adapter according to either claim 2, wherein the electricity conducting device has an angle-iron shape connected to said adapter, from which extends at least one first or one second tongue forming the first or second flexible means.

4. The adapter according to claim 3, wherein at least one of the tongues has a boss at a free end.

5. The adapter according to claim 1, wherein the electricity conducting device is formed as a bent metal plate.

6. An assembly for fixing a windscreen wiper provided with a heating device to an arm of said wiper, comprising:
a connector on which are positioned a second electrical contact and an adapter according to claim 1.

7. The fixing assembly according to claim 6, wherein the electricity conducting device is in contact with the second electrical contact via a second tongue of the electricity conducting device.

8. A windscreen wiper comprising:
a heating device comprising a fixing assembly according to claim 6.

9. The wiper according to claim 8, wherein the second electrical contact feeds said heating device with electricity, this latter device comprising at least one heating resistance implanted on at least one vertebra of the wiper.

10. A vehicle windscreen wiper comprising an arm provided with a yoke, the windscreen wiper comprising:
a heating device; and
a fixing assembly for fixing the windscreen wiper provided with the heating device to the arm of said wiper, comprising a connector on which are positioned a second electrical contact and an adapter according to claim 3.

11. The windscreen wiper according to claim 10, wherein the electricity conducting device comes to bear against a first electrical contact of the yoke and against the second electrical contact of the connector.

12. The windscreen wiper according to claim 11, wherein the first tongue extends longitudinally, said adapter being conformed to be integrated into the yoke by a rotation about a shaft transverse to the longitudinal direction of the arm.

13. The windscreen wiper according to claim 11, wherein the second tongue extends transversely relative to the longitudinal direction of the arm, said adapter being conformed to receive the connector through longitudinal translation.

14. The windscreen wiper according to claim 11, wherein the second tongue extends longitudinally, said adapter being conformed to be integrated into the connector by a rotation about a shaft transverse to the longitudinal direction of the arm.
